(19) United States
(12) Patent Application Publication
(10) Pub. No.: US 2025/0036134 A1
(43) Pub. Date: Jan. 30, 2025

(54) METHOD FOR FILTERING INPUTS TO A LOCALIZATION METHOD OF AN AUTONOMOUS VEHICLE

(71) Applicant: Jungheinrich Aktiengesellschaft, Hamburg (DE)

(72) Inventors: Hauke Gathmann, München (DE); Dennis Schradick, München (DE); Max Stähr, München (DE)

(21) Appl. No.: 18/783,708

(22) Filed: Jul. 25, 2024

(30) Foreign Application Priority Data
Jul. 25, 2023 (EP) 23187569.1

(51) Int. Cl. G05D 1/246; G05D 1/622; G05D 107/70; G05D 111/10

(52) U.S. Cl. CPC G05D 1/2464; G05D 1/622; G05D 2107/70; G05D 2111/17

(57) ABSTRACT

The present invention relates to a method for filtering inputs to a localization method of an autonomous vehicle (10) in an operating environment (U), comprising the steps of: providing a predefined occupancy map which represents known objects (W) present in the operating environment (U); generating an optimized data structure which represents occupied cells in a display of the occupancy map in a coordinate system; detecting the operating environment (U) of the vehicle (10) by means of at least one sensor unit (12) which is configured to detect objects in the operating environment (U) and their distances from the vehicle (10), wherein each detected object is assigned a measured value (M1, M2) in the coordinate system; and for each measured value (M1, M2) searching within a search radius around the measured value (M1, M2) for an occupied cell in the optimized data structure; if an occupied cell is found within the search radius, forwarding the measured value (M1) to a subsequent localization method, and, if no occupied cell is found within the search radius, discarding the measured value (M2).

The present invention relates to a method for filtering inputs to a localization method of an autonomous vehicle in an operating environment, a corresponding localization method and an autonomous industrial truck, the control unit of which is configured to carry out such a filtering method.

In the field of logistics, there has been an increase lately in the use of autonomous vehicles that can carry out movements in an operating environment and transport loads based on predefined work orders. In order to be able to perform such tasks, it is necessary to know the current location of such vehicles with a high degree of precision, not only in order to be able to reliably approach the pick-up and transfer positions for the loads to be transported, but also in order to be able to rule out from the outset, for example, undesirable interactions and in particular collisions with obstacles present in the operating environment.

In addition to the use of position-determining devices that allow such vehicles to determine their own position, for example via triangulation of transmitter signals or on the basis of markers positioned in the operating environment, alternative localization strategies have become known in which images of the environment of the vehicles are captured using suitable sensor units and compared to a predefined map, wherein the vehicles can be localized with high precision using pattern recognition by comparing the sensor data and the map data. Accordingly, in such applications, localizations are carried out on existing static maps, wherein for reliable operation with high precision, both a high frequency of such localization methods and the capture of a large amount of sensor data or a high granularity of the images of the environment are desired. Due to the correspondingly high number of data points, such localization methods are relatively computationally intensive, which is further intensified by the desired high frequency of such methods.

In addition, under certain circumstances, incorrect measurements or detections of objects may occur when capturing the environment, in particular if one of the detection devices of such a vehicle is tilted toward the ground, for example due to driving over an uneven surface, so that the driving surface itself would be detected and consequently interpreted as an environment feature that would have to be compared to the aforementioned occupancy map. This would not only drastically increase the already high computing requirements, but there would also be a risk that such incorrect measurements could make it difficult or even impossible to localize the vehicle.

It is therefore an object of the present invention to provide a method for filtering inputs to such a map-based localization method, by means of which erroneous measured values from the operating environment around the vehicle can be discarded at an early stage in an efficient manner in order to be able to carry out the subsequent actual localization method more efficiently and reliably.

For this purpose and to achieve the object just formulated, a method according to the invention for filtering inputs to a localization method of an autonomous vehicle in an operating environment comprises the steps of: providing a predefined occupancy map which represents known objects present in the operating environment; generating an optimized data structure which represents occupied cells in a display of the occupancy map in a coordinate system; detecting the operating environment of the vehicle by means of at least one sensor unit which is configured to detect objects in the operating environment and their distances from the vehicle, wherein each detected object is assigned a measured value in the coordinate system; and for each measured value searching within a predetermined search radius around the measured value for an occupied cell in the optimized data structure; if an occupied cell is found within the search radius, forwarding the measured value on to a subsequent localization method, and, if no occupied cell is found within the search radius, discarding the measured value.

Accordingly, the method according to the invention can be used to efficiently filter measured values provided by the at least one sensor unit in such a way that measured values which do not have an occupied cell in the data structure representing the occupancy map within their predetermined search radius are not input to the localization method, thereby allowing a significant reduction in the data to be processed and an overall more robust implementation of the downstream localization method. It should be noted that a predefined occupancy map is already used for this purpose, which map may already be available in a suitable format in the processing unit responsible for the following method steps.

In particular, the coordinate system used can be a global Cartesian coordinate system of the operating environment, in which system such occupancy maps and data structures can be handled in an advantageous manner.

Accordingly, assigning the measured values in the coordinate system to the detected objects may further comprise transforming the measurement outputs of the at least one sensor unit into the global Cartesian coordinate system based on a current estimate of the pose of the vehicle. In order to be able to set the sensor data, which are usually provided in a coordinate system with the origin at the center of the vehicle, in relation to the occupancy map or the optimized data structure, it is first necessary to know or estimate the current position and orientation of the vehicle with respect to the global Cartesian coordinate system, wherein the pair of values consisting of the current position and current orientation of the vehicle is referred to as its pose. Examples of techniques for producing a current estimate of the pose of the vehicle include starting from a last known pose during ongoing operation or when resuming operation of the vehicle without interim changes in the pose, or, when starting up the vehicle at an initially unknown position, setting the corresponding pose by starting from a corresponding starting field with a known pose.

Similarly, the current estimate of the pose of the vehicle can be used to set the aforementioned search radius by setting the search radius based on the current estimate of the pose of the vehicle and a maximum assumed error.

For example, the search radius can be set by means of a projection using a maximum assumed angular error and a maximum assumed location error of the estimated pose with respect to the distance to the corresponding measured value. Such maximum assumed errors regarding the angle and location of the pose can be determined in various data-based methods before the vehicle is put into operation, for example by comparing the deviations between navigation using an aforementioned sensor unit and navigation using markers in various test series.

By using the procedure just described for setting the corresponding search radii, the search radius associated with each measured value will be different depending on its distance from the vehicle so that the geometric relationships between the occupancy map, the vehicle and the corresponding measured value can be taken into account with high accuracy. Although in principle alternative variants of the method according to the invention would also be possible in which a corresponding search radius is determined in a different way or even a fixed value for such a search radius is assumed, such variants would lead to a less reliable rejection of erroneous or undesirable measured values.

Furthermore, it should be noted that the optimized data structure should be characterized in that it allows the presence of an occupied cell within the search radius around a corresponding measured value to be checked in the most efficient way possible. It turns out that a “brute force” method for comparing all possible occupied cells or objects present in the operating environment of the predefined occupancy map with the position of the measured value or the search radius thereof can also be extremely computationally intensive if a large number of measured values or occupied cells having a high degree of granularity are present because they would each have to be compared individually with one another.

Accordingly, the optimized data structure can be, for example, a search tree and in particular a k-d tree. Such data structures are characterized by the fact that they already contain distance information or neighborhood information of the individual entries, which makes them suitable for significantly simplifying the verification of the presence of an occupied cell within the search radius around each measured value or for significantly reducing the corresponding computational effort. Thus, even with a high number of measured values to be examined and a high frequency of the downstream localization method, the method according to the invention for filtering the inputs to the localization method can be carried out reliably with relatively little additional computational effort, wherein the savings in terms of computational effort achieved in the downstream localization method clearly outweigh the effort for carrying out the filtering method and at the same time the precision of the localization method can be increased.

Thus, in accordance with a further aspect, the present invention further relates to a localization method of an autonomous vehicle in an operating environment based on a comparison of sensor data from at least one sensor unit of the vehicle with a predefined occupancy map of the operating environment in order to determine a current pose of the vehicle, wherein the sensor data are filtered by means of a method of the type just described before carrying out the localization.

In addition, according to a further aspect, the present invention relates to an autonomous industrial truck comprising at least one sensor unit which is configured to detect objects in the operating environment of the industrial truck and their distances from the industrial truck, and a control unit coupled to the at least one sensor unit, wherein the control unit is configured to carry out the corresponding filtering method according to the invention on the basis of a provided occupancy map and sensor data supplied by the at least one sensor unit.

Furthermore, the control unit can also be configured to carry out a localization method for determining a current pose of the industrial truck based on the measured values transmitted from the method and the occupancy map.

While, first of all, different embodiments of sensor units in the industrial truck according to the invention would be conceivable provided that they are capable of detecting objects in the operating environment of the industrial truck and their distances, i.e., for example also 3D cameras or similar devices, according to the invention the at least one sensor unit can be formed in particular by a 2D laser scanner.

Such laser scanners periodically cover their scanning area on a predefined scanning plane and, when an object is detected at a certain angle, provide the corresponding distance data, which can be transferred in a suitable manner into any coordinate system. The corresponding scan planes are usually positioned relatively close to the driving surface and aligned parallel to it.

In this case, the control unit can be configured to carry out the method according to the invention at a frequency of at least 20 Hz, preferably at least 50 Hz, in order to always be able to pass on reliable input data to a downstream localization algorithm, which can be carried out accordingly at the same frequency. In this case, the highest possible frequency of this localization algorithm is desirable in order to be able to determine the current pose of the industrial truck according to the invention with a high degree of precision even at high speeds.

Although the present invention is in principle initially applicable to any design of industrial trucks, the industrial truck can in particular be designed as a pallet shuttle and the sensor plane of the at least one sensor unit can run at most 15 cm above a driving surface. The particular suitability of the method according to the invention for such vehicles is that in such pallet shuttles with their function-related low construction height and correspondingly low scanning plane, situations can arise even at small tilt angles of the vehicle body in which the scanning plane protrudes into the driving surface and accordingly objects which are not included in the occupancy map would be incorrectly detected in such an area and would thus make the localization of the vehicle significantly more difficult. Sensors arranged low are also particularly susceptible to reflections on the driving surface, which can similarly provide erroneous measured values and can be efficiently discarded using the filter method according to the invention.

Further features and advantages of the present invention will become even clearer from the following description of an embodiment, when said embodiment is considered together with the accompanying drawings. In detail:

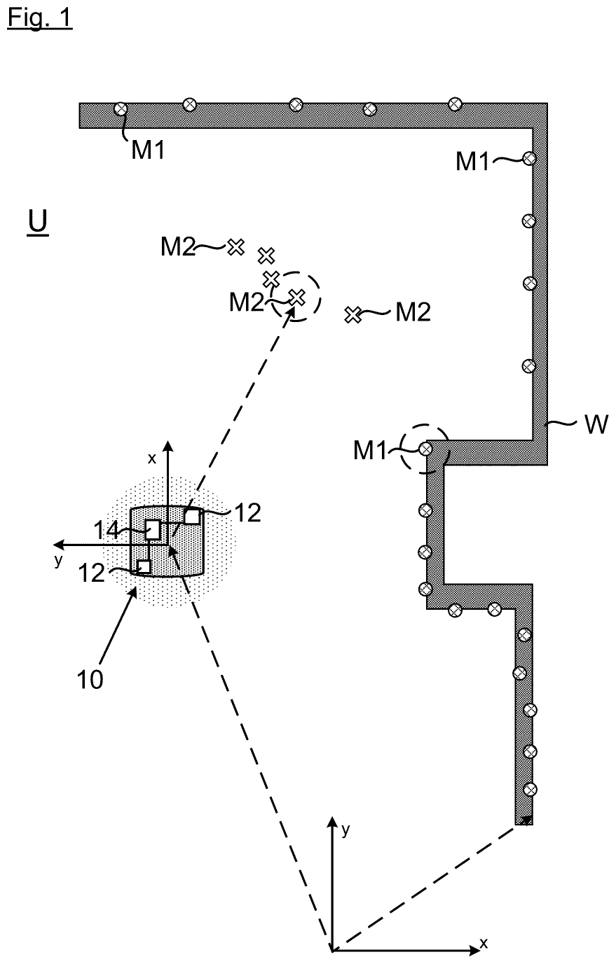

FIG. 1 shows a schematic representation of an operating state of a vehicle according to the invention in an operating environment during implementation of a method according to the invention in plan view;

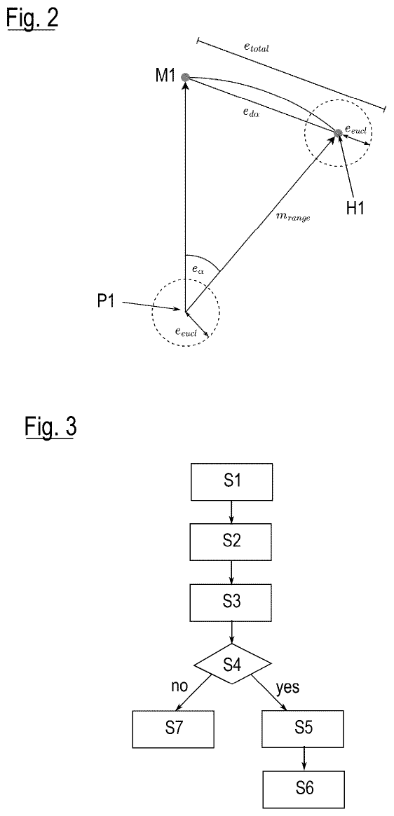

FIG. 2 shows a schematic diagram illustrating the determination of a search radius in the corresponding method; and

FIG. 3 shows a flow chart for explaining a method according to the invention.

In FIG. 1, an industrial truck 10 according to the invention is shown schematically in a schematic plan view, which is designed in the form of a pallet shuttle and is located in an operating environment U in which it can carry out different operating tasks, for example transport of objects between transfer stations (not shown here).

The pallet shuttle 10 has a relatively low overall height and an almost square outline when viewed from above and is equipped with a plurality of sensor units 12 designed as 2D laser scanners for detecting objects in its environment as well as a control unit 14 coupled to the sensor units 12. Due to their respective scanning ranges and their arrangement on the vehicle 10, the sensor units 12 allow all-round detection of the environment of the vehicle 10 over a full 360°.

As can be seen from FIG. 1, the vehicle 10 is currently located in the already mentioned operating environment U, which is delimited by a wall W. In this case, the environment U is assigned a global Cartesian coordinate system, which is indicated by corresponding coordinate axes in FIG. 1, wherein the area to be considered for the method according to the invention is divided into a plurality of (virtual) cells according to the grid pattern also shown. The vehicle itself can also be assigned a coordinate system, as indicated in FIG. 1, because measured values of the sensor units 12 must first be interpreted in relation to the position and orientation of the vehicle 10.

The vehicle 10 and, in particular, its control unit 14 also have an occupancy map based on this grid, which represents known objects present in the operating environment U and, in the present case, the wall W, and classifies the corresponding cells of the grid as occupied or unoccupied. Based on the data provided by the sensor units 12 regarding respective distances to detected objects depending on the current detection angle and by comparing this to the wall W encoded in the occupancy map, the vehicle is able to localize itself within the operating environment U and in particular to determine its own pose, i.e., the position and orientation of the vehicle 10.

For this purpose, numerous measured values are illustrated in FIG. 1, wherein some examples of the measured values actually located in the immediate vicinity of the wall, symbolized by dots, are designated with M1, while further examples of additional erroneous measured values, symbolized by X's, are designated with M2. In this case, the accumulation of erroneous measured values M2 can be caused, for example, by reflections on the driving surface or an unevenness of this surface, wherein such an unevenness can lead, for example when the vehicle 10 drives over it, to the corresponding sensor units 12 being tilted toward the ground in a certain direction and can therefore classify it as an obstacle or object as soon as the corresponding scanning plane intersects the driving surface.

In order to filter out or reject the measured values M2, which are referred to here as incorrect, before carrying out the aforementioned localization method, the vehicle 10 carries out a filtering method according to the invention with the aid of its control unit 14, in which a search for occupied cells is carried out for each of the measured values M1 and M2 in the occupancy map available here or in an optimized data structure based thereon, wherein an estimate of the current pose of the vehicle 10 is also used as a basis. This method will be explained in more detail below in connection with the flow chart in FIG. 3, wherein it will be seen that within the corresponding search radii around the measured values M1, shown in some examples by dashed circles in FIG. 1, there is at least one occupied cell because the wall W encoded in the occupancy map is located within its environment, while for the erroneous measured values M2 no occupied cell is found in their vicinity and in particular within the corresponding search radius because they are far away from the wall W and there are no other objects in their vicinity in the occupancy map.

By filtering the recorded measured values M1 and M2 and by only passing on the verified measured values M1 to a downstream localization method, a significant improvement in the efficiency and reliability of this localization method can be achieved, which more than compensates for the additional computational effort for the filtering method just described.

With reference to FIG. 2, it will now be further explained how the particular search radius is set for each of the measured values M1 and M2. For this purpose, a currently estimated position P1 and a currently estimated orientation of the vehicle 10 in the operating environment U with respect to the global coordinate system are assumed, which together represent a current estimate of the pose of the vehicle 10. Furthermore, based on previously performed data-based methods, a maximum assumed location error or a maximum assumed angle error of the corresponding estimated pose can be set, which has been determined, for example, by comparison series of laser navigation of the type described here and marker navigation.

In order to determine the corresponding search radius of one of the measuring points M1 assuming the maximum possible errors for the location and angle of the pose, an auxiliary point H1 is constructed on a circle with the position P1 as its center starting from the measuring point M1 considered here and taking into account the maximum possible angle error e_{α}, the distance e_{dα} (circular chord) of which from the measuring point M1 depends on the distance of the measured value M1 to the position P1, which is referred to here as m_{range}.

In addition to this distance e_{dα} between the measured value M1 and the auxiliary point H1, the maximum assumed location error e_{eucl} is added in extension to this distance, resulting in the search radius around the measured value M1, referred to here as eₜₒₜₐₗ, within which the occupancy map is to be searched for occupied cells according to the principle described above. In FIG. 2, the corresponding maximum assumed errors are not to be understood as being to scale; when determining corresponding deviations in experimental test series, it has been shown that the maximum assumed angular error will generally be in the range of about 1° or less, while values of about 10 cm or less are typical for the location error.

On this basis, an individual search radius and the predetermined maximum assumed error of the location e_{eucl} or angle e_{α}, can be determined for each of the measured values M1 or M2 from FIG. 1 on the basis of the estimated pose of the vehicle 10, whereupon a comparison can then be carried out with the objects present in the occupancy map within the resulting search radius eₜₒₜₐₗ.

To clarify the method to be carried out for this purpose, reference is made last of all to FIG. 3, in which, in a first step S1, the predefined occupancy map of the operating environment U is input into the vehicle 10 and can, for example, be created beforehand using conventional measurement methods of the environment U in an iterative method and is initially assumed to be static as long as no changes are made to the operating environment U that would require a renewed input of a corresponding modified occupancy map to the vehicle 10. Accordingly, this map is only provided once, while the method steps described below are carried out at a high frequency, for example 20 Hz or 50 Hz.

First, in step S2, the vehicle 10 generates an optimized data structure from the occupancy map by means of its control unit 14, wherein the optimized data structure represents occupied cells in a display of the occupancy map in a coordinate system and in particular in the global Cartesian coordinate system of the operating environment U, for example in the form of a search tree and in particular in the form of a k-d tree, wherein corresponding algorithms for generating such a data structure from an occupancy map are known and can be implemented efficiently.

Subsequently or in parallel thereto, in step S3 the vehicle 10 detects the operating environment U by means of its sensor units 12 and consequently determines the already aforementioned measured values M1 and M2, which each correspond to spatial coordinates in which objects have been detected. After corresponding measured values have been generated in the coordinate system also used by the optimized data structure, which may require, for example, a coordinate transformation between a reference system of the vehicle 10 and the global Cartesian coordinate system based on a current estimate of the pose of the vehicle 10, a search is carried out in step S4 for an occupied cell in the optimized data structure for each of the measured values M1 and M2 within the specific search radius explained in connection with FIG. 2.

If it turns out during this search that an occupied cell is found within the search radius (“yes” in step S4), the corresponding measured value is forwarded to a subsequent localization method in a step S5, which in step S6, on the basis of all accepted measured values output in step S5, localizes the current pose of the vehicle 10 by comparing it to the occupancy map using a pattern recognition method.

If, however, it is detected in step S4 that no occupied cell is found within the search radius (“no” in step S4), the corresponding measured value is discarded in step S7 and thus not entered as input to the localization method in S6.

Accordingly, by carrying out the method according to the invention, input of erroneous measured values or measured values that are not consistent with an occupancy map to a subsequent localization method is ensured so that this can be carried out efficiently and reliably. By using an appropriate search tree and in particular a k-d tree in the search for occupied cells within the search radius of each measured value, an extremely efficient implementation of the filter method according to the invention can furthermore be achieved.

1. A method for filtering inputs to a localization method of an autonomous vehicle in an operating environment, the method comprising:
providing a predefined occupancy map representing known objects present in the operating environment;
generating an optimized data structure representing occupied cells in a display of the occupancy map in a coordinate system;
detecting the operating environment of the vehicle using at least one sensor unit, wherein the at least one sensor unit is configured to detect objects in the operating environment and a distance of each object from the vehicle, and wherein each detected object is assigned a measured value in the coordinate system;
for each measured value, searching within a search radius around the measured value for an occupied cell in the optimized data structure;
forwarding the measured value to a subsequent localization method if an occupied cell is found within the search radius; and
discarding the measured value if no occupied cell is found within the search radius.

2. The method of claim 1, wherein the coordinate system is a global Cartesian coordinate system.

3. The method of claim 2, wherein assigning the measured values in the coordinate system to the detected objects comprises transforming measurement outputs of the at least one sensor unit into the global Cartesian coordinate system based on a current estimate of a pose of the vehicle.

4. The method of claim 1, wherein the search radius is set based on a current estimate of a pose of the vehicle and a maximum assumed error.

5. The method of claim 1, wherein the search radius is set based on a projection of a maximum assumed angular error and a maximum assumed position error of a pose of the vehicle with respect to the distance to each measured value.

6. The method of claim 1, wherein the optimized data structure is a search tree.

7. The method of claim 1, further comprising locating the autonomous vehicle in the operating environment based on a comparison of sensor data of the at least one sensor unit with the predefined occupancy map of the operating environment.

8. An autonomous industrial truck comprising:
at least one sensor unit; and
a control unit coupled to the at least one sensor unit, wherein the control unit is configured for:
receiving a predefined occupancy map representing known objects present in an operating environment and sensor data supplied by the at least one sensor unit;
generating an optimized data structure representing occupied cells in a display of the occupancy map in a coordinate system;
detecting the operating environment of the autonomous industrial truck using the at least one sensor unit, wherein the at least one sensor unit is configured to detect objects in the operating environment and a distance of each object from the autonomous industrial truck, and wherein each detected object is assigned a measured value in the coordinate system;
for each measured value, searching within a search radius around the measured value for an occupied cell in the optimized data structure;
forwarding the measured value to a subsequent localization method if an occupied cell is found within the search radius; and
discarding the measured value if no occupied cell is found within the search radius.

9. The autonomous industrial truck of claim 8, wherein the control unit is further configured for performing a localization method to determine a current pose of the industrial truck based on the forwarded measured values and the occupancy map.

10. The autonomous industrial truck of claim 8, wherein the at least one sensor unit comprises a 2D laser scanner.

11. The autonomous industrial truck of claim 8, wherein the control unit has an operating frequency of at least 20 Hz.

12. The autonomous industrial truck of claim 8, wherein the autonomous industrial truck comprises a pallet shuttle, and wherein a sensor plane of the at least one sensor unit runs at most 15 cm above a driving surface.

13. The method of claim 6, wherein the search tree comprises a k-d tree.

14. The method of claim 7, wherein the sensor data comprises the measured values.

15. The autonomous industrial truck of claim 8, wherein the control unit has an operating frequency of 50 Hz.

16. The autonomous industrial truck of claim 8, wherein the coordinate system is a global Cartesian coordinate system.

17. The autonomous industrial truck of claim 16, wherein assigning the measured values in the coordinate system to the detected objects comprises transforming measurement outputs of the at least one sensor unit into the global Cartesian coordinate system based on a current estimate of a pose of the autonomous industrial truck.

18. The autonomous industrial truck of claim 8, wherein the search radius is set based on a current estimate of a pose of the autonomous industrial truck and a maximum assumed error.

19. The autonomous industrial truck of claim 8, wherein the search radius is set based on a projection of a maximum assumed angular error and a maximum assumed position error of a pose of the autonomous industrial truck with respect to the distance to each measured value.

20. The autonomous industrial truck of claim 8, wherein the optimized data structure is a search tree.

21. The autonomous industrial truck of claim 20, wherein the search tree comprises a k-d tree.

22. The autonomous industrial truck of claim 8, wherein the control unit is further configured for locating the autonomous industrial truck in the operating environment based on a comparison of sensor data of the at least one sensor unit with the predefined occupancy map of the operating environment, and wherein the sensor data comprises the measured values.
